(19) United States
(12) Patent Application Publication
(10) Pub. No.: US 2015/0065235 A1
(43) Pub. Date: Mar. 5, 2015

(54) COMPUTER-BASED SYSTEM AND METHOD FOR TRACKING ACTIVITY OF CASINO GAME PLAYERS AND REWARDS

(71) Applicants: Zaven Esmaili, Los Angeles, CA (US); Erwin Manalo, West Covina, CA (US)

(72) Inventors: Zaven Esmaili, Los Angeles, CA (US); Erwin Manalo, West Covina, CA (US)

(73) Assignee: The Bicycle Casino, Inc., Bell Gardens, CA (US)

(21) Appl. No.: 14/101,115

(22) Filed: Dec. 9, 2013

Related U.S. Application Data
(60) Provisional application No. 61/873,728, filed on Sep. 4, 2013.

(51) Int. Cl. G07F 17/32

(52) U.S. Cl. CPC G07F 17/3206
USPC 463/29

(57) ABSTRACT

A computer-based method and a system for awarding points to players of a casino game by keeping track of plays made by the players. The system includes a processor connected to a play sensor, an identification sensor and a memory. The identification sensor detects a first player-identifying device associated with a first player. The memory stores a point count for each player. The play sensor detects each play made by the first player, and upon detection of the play, the processor increments a point count for the first player. The point count increment may be based on the predetermined value of each play of the casino game. The processor can further store the date and time of each play of the first player in the memory in order to keep track of times of each play made by the players.

### CROSS REFERENCE TO RELATED APPLICATIONS

This application claims the benefit of provisional patent application Ser. No. 61/873,728 filed Sep. 4, 2013 for PLAYER TRACKING SYSTEM, which is incorporated in this application as if fully set forth herein.

### BACKGROUND OF THE INVENTION

1. Field of the Invention

The present invention relates to methods and systems for tracking data of casino game players.

2. Description of Related Art

Casinos often reward frequent players by offering them monetary rewards, free stays at hotels, free dining at restaurants, and various other rewards. Adequate rewards may encourage the players to return to a particular casino. However, these rewards fail to provide an adequate incentive for a player to increase his/her frequency of play. There is a need in the art for a rewarding mechanism that provides an adequate incentive for a player to make more plays to receive higher rewards. In addition, there is a need for a computer-based rewarding mechanism to encourage a player to play more often in higher stakes games.

### SUMMARY OF THE INVENTION

A computer-based method and a system for awarding and tracking points for casino game players based on the number of plays that the respective players make in casino games.

Casino game players are each associated with a player-identifying device (player ID). The computer-based system includes an identification sensor that detects the player-identifying device. A processor connected to the identification sensor identifies the player. The processor sets the player's status to active. A memory is connected to the processor for storing a point count for the player. A play sensor is connected to the processor that detects each play of the player when the player's status is active. The processor increments a point count for the player when the play sensor detects a play made by the player and stores the incremented point count in the memory. The system increments point counts for every player that has a player ID upon detection of each play made by the player.

The processor stores play counts of a player as sensed by the play sensor and stores the accumulated play count of the player over a predetermined period of time in the system memory. The processor can determine a player's accumulated point count based on the stored play count. The play count of a player may be for example, the number of hands played by the player in a card game for a certain period of time.

The processor stores the date and time of each play made by a player in the memory. A predetermined value of each play of a casino game can be used to determine the point count for each play. For example, each play of a high-stakes casino game may correspond to a higher point count increment than each play of a low-stake game.

Players rewards are based on respective accumulated points. An advantageous feature of the system is that players have the incentive of making more plays to receive higher points in order to qualify for more valuable rewards.

### BRIEF DESCRIPTION OF THE DRAWINGS

The exact nature of this invention, as well as the objects and advantages thereof, will become readily apparent upon consideration of the following specification in conjunction with the accompanying drawings in which like reference numerals designate like parts throughout the figures thereof and wherein:

FIG. 1 is a block diagram illustrating components of a computer-based system for awarding points to players of a casino game;

FIG. 2 is a block diagram illustrating components of a computer-based system for awarding points to a plurality of players of a casino game;

FIG. 3 is a schematic illustration of an infrastructure of the computer-based system;

FIG. 4 is a schematic illustration of hardware used to implement the computer-based system;

FIG. 5 is a flowchart diagram showing a computer-based method of incrementing the point counts;

FIG. 6 is a flowchart diagram showing a computer-based process of incrementing the point counts;

FIG. 7 is a flowchart diagram showing a computer-based process of incrementing the point counts;

FIG. 8 is a flowchart diagram showing a computer-based method of incrementing the point counts and keeping track of start and end times of each play;

FIG. 9 is a flowchart diagram showing the steps of updating a database stored in the memory;

FIG. 10 is a flowchart diagram showing a computer-based method of updating a database based on plays made by each player of a casino game;

FIG. 11 is a tree diagram showing the method steps related to the dealer coordinator, the dealer and the players;

FIG. 12 is a block diagram illustrating a computer-based system for issuing player-identifying devices and redeeming accumulated points; and

FIG. 13 is an illustration of a display interface for player tracking software with access to the database.

### DETAILED DESCRIPTION OF THE PREFERRED EMBODIMENTS

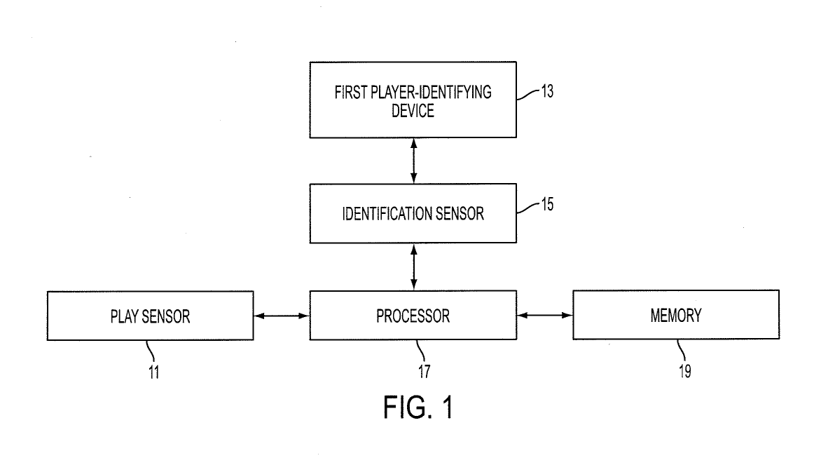

FIG. 1 is a block diagram illustrating components of a computer-based system for awarding points to players of a casino game based on the respective plays made by the players. The computer-based system utilizes at least one processor 17. A “processor” as used hereinafter may refer to a single processor or multiple processors. For example, the multiple processors may be connected through a cloud network, wireless communication link, the Internet or other communication means to perform the described tasks without limiting the scope of the present invention. The processor 17 is connected to a play sensor 11, an identification sensor 15 and a memory 19.

The identification sensor 15 detects a first player-identifying device (player ID) 13. Upon detection of the first player ID 13, the processor 17 sets the first player's status to active. The memory 19 stores a point count for the first player. The casino may reward a player based on the respective point count. For example, higher point counts can qualify the player for more valuable rewards.

The play sensor 11 detects each play of the first player when the first player's status is active. A “play” as used hereinafter refers to an action of playing or betting by a player, or collection of bets made by the players in a casino game. For example, a play can refer to a hand played or a round of betting in a casino card game. In an embodiment, the play sensor 11 may be a chip-drop sensor that detects collection of chips. For example, when the chips are collected, the processor 17 determines that the first player has played a hand. The processor 17 increments the point count for the respective player as each hand is detected.

The processor 17 increments the point count of the first player when the play sensor 11 detects a play by the first player and stores the incremented point count in the memory 19. The system similarly increments point counts for other players with active statuses upon detection of the respective plays.

A play sensor 11 can be utilized to determine placement of a bet by the player before collection of bets. For example, multiple play sensors 11 can be utilized, each being placed in proximity of one of the players to detect placement of bets (e.g., chips) before collection of bets. For example, the point count can be incremented based on the number of chips or bets placed by the respective player on a betting area of a casino game table. In other embodiments, the play sensor 11 can automatically or with the assistance of the dealer detect a play based on other factors.

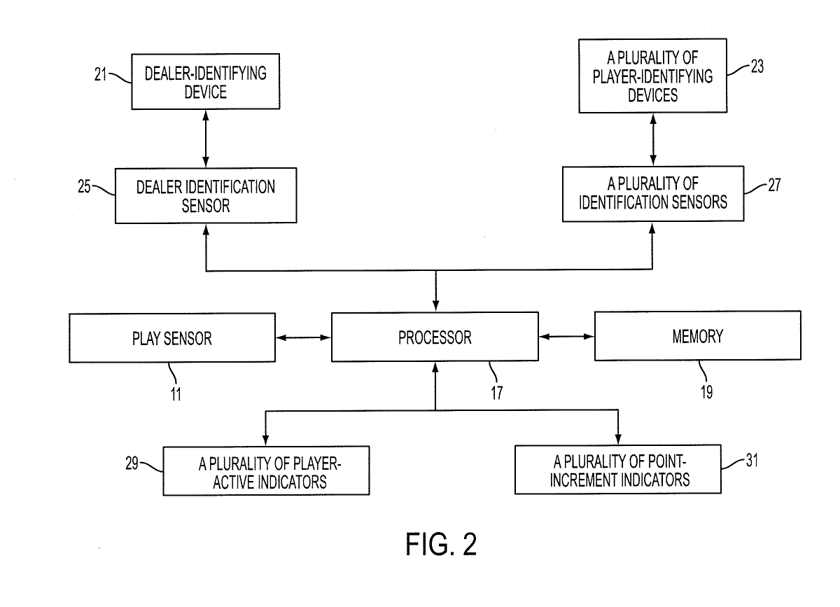

Referring now to FIG. 2, a dealer identification sensor 25 is connected to the processor 17 for detecting a dealer-identifying device 21. Upon detection of the dealer-identifying device 21, the processor 17 activates detection by the play sensor 11. In another embodiment, the processor 17 increments the respective point counts even if the dealer-identifying device 21 is not utilized.

Each of a plurality of players carry one of the plurality of player IDs 23. A plurality of identification sensors 27 are connected to the processor 17 for detecting the plurality of player IDs 23. The processor 17 identifies the players associated with each of the player IDs 23.

The processor 17 is connected to a plurality of player-active indicators 29, each corresponding to one of the players. When the player IDs 23 are detected, the processor 17 sets the respective player-active indicators 29 to an on state. For example, the plurality of player-active indicators 29 may be Light-Emitting Diodes (LEDs) that would blink or be set to an on state for a predetermined time period when the respective player is in an active state.

The processor 17 is connected to a plurality of point-increment indicators 31, each corresponding to one of the players. When the processor 17 increments the point counts of the players, the processor 17 may set the respective point-increment indicators 31 to an on state. For example, the plurality of point-increment indicators 31 can be LEDs that would blink or be set to an on state for a predetermined time period when the respective player is in an active state.

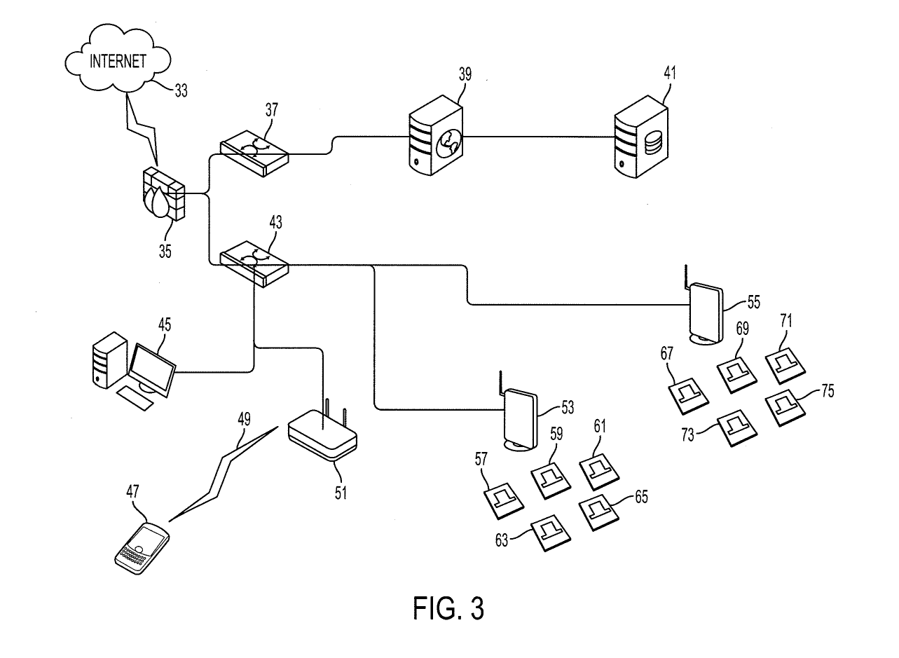

Referring to FIG. 3, a first processor 53 is connected to a first plurality of identification sensors 57, 59, 61, 63 and 65, each sensor detecting an identity device of a different player. For example, the first identification sensor 57 can be positioned on a casino game table near a first seat for a first player, and the second identification sensor 59 can be positioned on the table near a second seat and similarly as to the remainder of the first plurality of identification sensors. The first plurality of identification sensors 57, 59, 61, 63 and 65 can be RFID (radio frequency identification) readers spaced apart from one another to minimize electromagnetic interference and maximize accuracy of detection. Although five sensors are shown in FIG. 3, one or any number of identification sensors can be utilized, depending on design needs such as the number of seats or players of a particular casino game.

A second processor 55 is connected to a second plurality of identification sensors 67, 69, 71, 73 and 75 positioned at a second casino game. The processors 53 and 55 can be connected to a web server 39 and a database 41 via network switches 37 and 43. The network switches 37 and 43 may be, for example, a Gigabit Ethernet Switch with 10/100/1000 Mbps (Megabits per second). The processors 53 and 55 can be connected to the foregoing hardware components or other hardware components via wireless communication or other communication means without limiting the scope of the present invention.

The web server 39 may be, for example, a Microsoft IIS (Internet Information Services) web server for providing a secure, easy-to-manage and modular platform. The database 41 may be, for example, a Microsoft SQL (Structure Query Language) Server for providing a cloud-ready information platform to allow access to player identification data, the point count, the start/end times for the plays, the start/end times of dealers and other data described herein. A dealer coordinator can activate, deactivate or control the computer-based system and monitor detected and tracked data using the dealer coordinator computer 45. Similarly, a floor man or manager can similarly monitor and control the operations of the computer-based system using a portable electronic device 47 (e.g., a smart phone). The portable electronic device 47 may be connected to the system via a Wi-Fi connection 49, a wireless access point 51 and the network switches 37 and 43. In addition, connection to the Internet may be provided through a firewall 35.

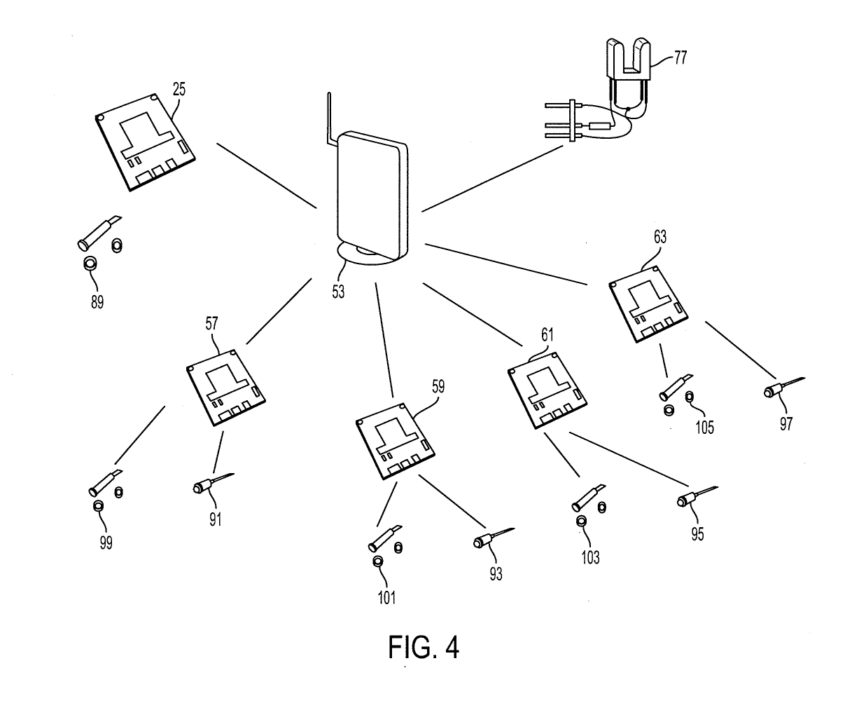

Referring now to FIG. 4, a dealer identification sensor 25 may be connected to the first processor 53 for detecting a dealer identification device. The dealer identification sensor 25 can be an RFID sensor that detects an RFID card associated with the dealer. Upon detection of the dealer identification device, the first processor 53 may activate detection of the play sensor 11 to start incrementing the point counts of each player based on the plays being made. The processor 17 also sets a dealer-active indicator 89 (e.g., an LED) to an on state when the dealer-identifying device 21 is detected.

The first processor 53 is connected to the identification sensors 57-63. Upon detection of the identification sensors 57-63, the first processor 53 sets the respective player-active indicators 99, 101, 103 and 105 to an on state. The respective player-active indicators 99, 101, 103 and 105 may be LEDs positioned near the respective seats of the players. The LEDs would blink or be switched to an on state for a predetermined amount of time to indicate that the respective player near the LED is in an active state.

The play sensor 11 may be, for example, a chipdrop sensor 77 that detects depositing of chips in a container. For example, the dealer collects the chips after each player makes plays. The dealer drops the chips into a drop box. The chip-drop sensor 77 generates a signal upon depositing of the chips. For example, the chip-drop sensor 77 may be an infrared break-beam sensor that generates an electrical signal upon depositing of the chips in the drop box.

Upon detection of each play by the play sensor 11, the first processor 53 increments the respective point counts for each of the players. In addition, the first processor 53 sets the respective point-increment indicators 91, 93, 95 and 97 to an on state for a predetermined period of time. The point-increment indicators 91, 93, 95 and 97 instill confidence and satisfaction in the respective active players because the players would acknowledge that they are indeed accumulating additional points by making additional plays.

Individual displays for each player or a common display can be provided at the casino game for displaying the respective point counts of players. Each player can further log into their respective accounts using a computer such as a portable electronic device (e.g., a smart phone) connected to the processor 17 and/or the memory 19 to view or redeem their respective point counts in substantially real time while playing the casino game or at a later time.

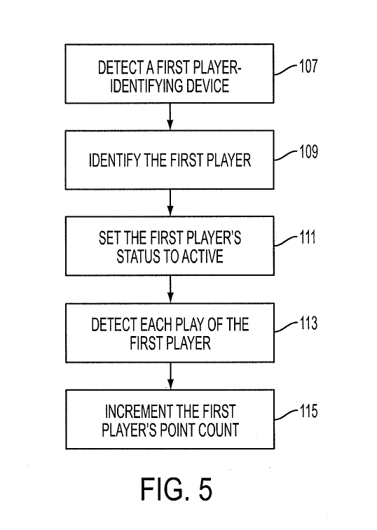

FIG. 5 is a flowchart diagram showing the computer-based process of incrementing the point counts according to an embodiment of the invention. In step 107, a first player ID 13 registered to a first player is detected. The processor 17 identifies the first player. For example, the first player ID 13 may be an RFID card with a unique RFID number. The processor 17 identifies the first player based on the unique RFID number. Alternatively, the first player ID 13 may be a portable electronic device such as a smart phone. The first player ID 13 may be registered to a unique identifying data that would be recognized by the identification sensor 15. For example, the identification sensor 15 may detect the unique identification data of the first player ID 13 via wireless communication (e.g., Bluetooth).

In step 111, the processor 17 sets the first player's status to active in step 111, and in step 113, the processor 17 detects each play of the first player as sensed by the play sensor 11. In step 115, the processor 17 increments the first player's point count when the play sensor 11 detects a play by the first player, and stores the incremented point count in the memory 19.

The point count increment for each play can be based on the predetermined value of the play for the casino game. For example, plays made at a high stakes casino game (e.g., a no-limit Poker game with high minimum buy-in requirements) may be rewarded more than low-stakes casino games (e.g., a low-limit Poker game). For example, in a high-stakes no-limit Poker game, the points of the active players of the high-stakes game may be incremented by 1.5 points per each play made whereas the points for a lower limit Poker game may be incremented by 1 point per each play made. Under such a rewarding mechanism, a player would be interested in making plays more frequently at a high-stakes game in order to qualify for more valuable rewards. The foregoing point increments are provided as examples. Various other point increments may be utilized based on the characteristics of the promotions and the casino games, and the membership or playing history of the respective players.

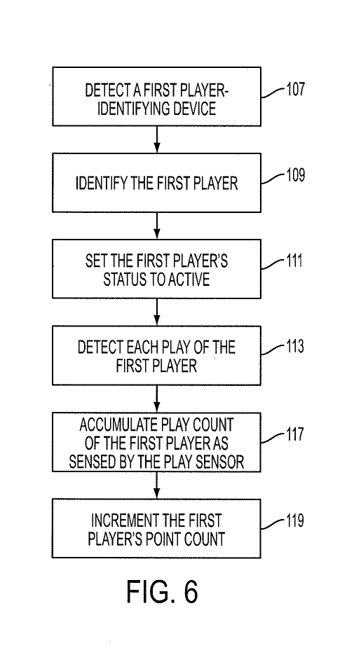

Referring now to another embodiment shown in FIG. 6, the processor 17 accumulates the first player's play count as sensed by the play sensor 11 and stores the accumulated play count of the first player in the memory 19. In step 119, the processor 17 determines or increments the first player's point count based on the accumulated play count. The first player or authorized casino personnel can retrieve the first player's respective point count and play count. The play count of the player may correspond to, for example, the number of hands played by the first player in a card game.

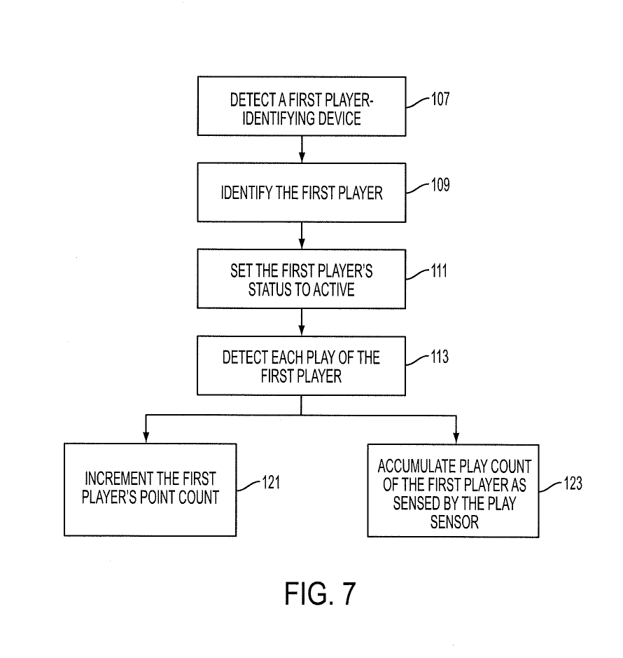

Referring now to another embodiment shown in FIG. 7, upon detection of each play in step 113, the processor 17 increments the first player's point count in step 121 and store the incremented point count in the memory 19. Furthermore, upon detection of each play in step 113, the processor 17 can further accumulate the first player's play count as sensed by the play sensor 11 and store the accumulated play count of the first player in the memory 19.

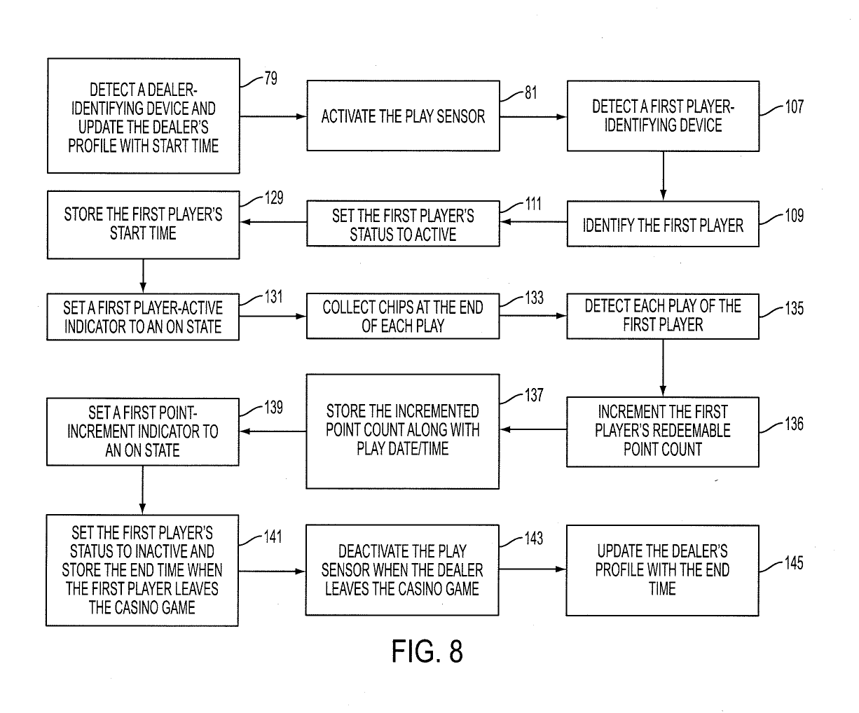

FIG. 8 is a flowchart diagram showing the computer-based process of incrementing the point counts and keeping track of date and time of each play. In step 79, the dealer is identified as discussed above with respect to FIG. 4. The processor 17 updates the dealer's profile by storing the start time of the identified dealer in the memory 19. The start time may correspond to the time that the dealer starts dealing the casino game. In step 81, the processor 17 activates detection by the play sensor 11. In steps 107, 109 and 111, the first player ID 13 is detected, the first player is identified, and the first player's status is set to active as discussed above with respect to FIG. 5.

Upon setting the first player's status to active or upon detection of the first player ID 13, the processor 17 stores the first player's start time. The start time may refer to the time that the first player has started playing the current casino game. In step 131, the first player-active indicator (e.g., an LED) can be set to an on state as discussed above with respect to FIG. 4.

In step 133, the chips are collected at the end of each play. The dealer or the players may deposit the chips and the dealer may collect the chips. In other embodiments, the chips can be collected by others or deposited automatically without limiting the scope of the present invention. In step 135, the play sensor 11 detects each play of the first player. Upon detection of the play made by the first player, the processor 17 increments the first player's point count in step 136.

In step 137, the processor 17 stores the incremented point count and stores the store the date and time of each play of the first player in the memory 19. In step 139, the processor 17 sets the first point-increment indicator 91 to an on state. The processor 17 continues to record each play and increment the point counts for active players.

When the identification sensor 15 no longer detects the first player ID 13, the processor 17 determines that the processor 17 has left the casino game and sets the first player's status to inactive. For example, the identification sensor 15 can be an RFID sensor that detects removal of the RFID device of the first player based on the respective RF electromagnetic field. When the first player's status is inactive, the respective point count is no longer incremented until the first player's status is set to active again. Other algorithms and criteria may be utilized to determine whether the first player has left the casino game. For example, the player ID can be a membership card with a magnetic strip such that swiping the membership card would indicate start and/or end for the respective player.

In step 143, when the dealer identification sensor 25 no longer detects the dealer-identifying device 21, the processor 17 determines that the dealer has left the casino game and deactivates the detection by the play sensor 11. For example, the dealer identification sensor 25 can be an RFID sensor that detects removal of the RFID device of the dealer based on the respective RF electromagnetic field. In an embodiment, when the dealer is replaced with another dealer, the play sensor 11 remains active. In other embodiments, other algorithms and criteria can be utilized to determine whether the dealer has left the casino game. For example, the dealer-identifying devices can be a dealer card with a magnetic strip such that swiping the dealer card would indicate start and/or end for the respective player. In step 145, when the dealer leaves the casino game, the processor 17 updates the dealer's profile with the end time.

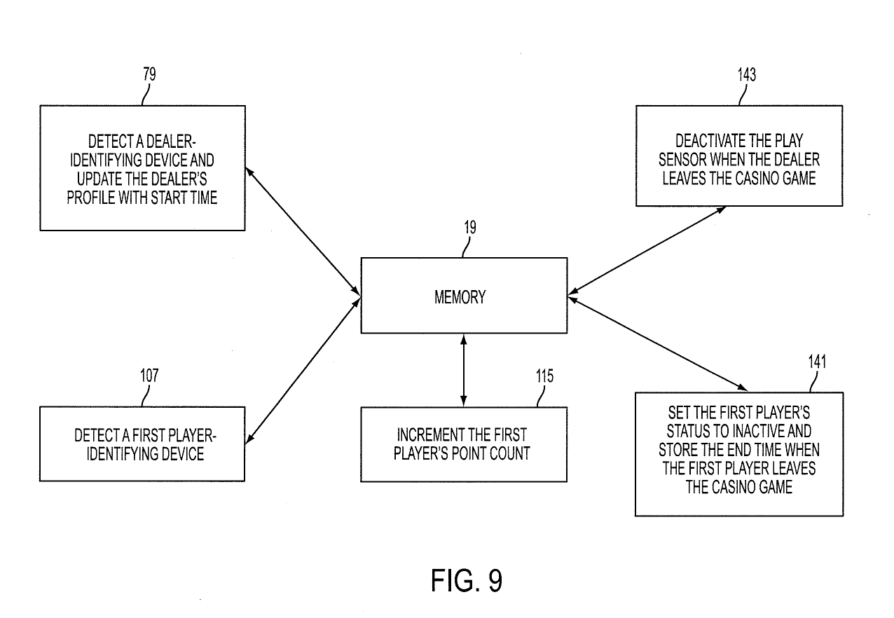

FIG. 9 is a flowchart diagram showing the steps of updating the database 41 stored in the memory 19. In steps 79, 107, 115, 141 and 143, the processor 17 updates the database 41 stored in the memory 19 as shown in FIG. 9 and as disclosed above with respect to FIG. 8.

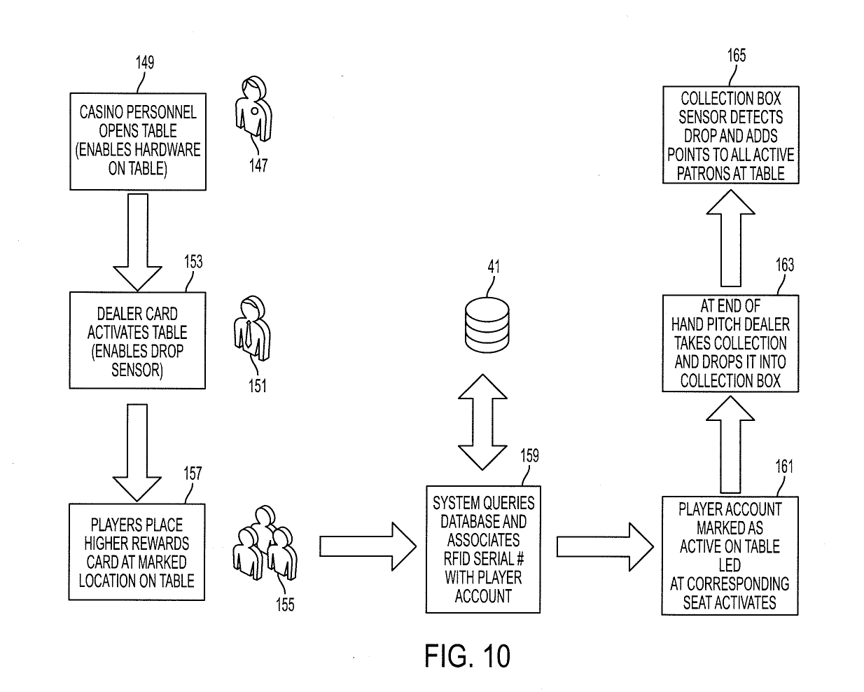

FIG. 10 is a flowchart diagram showing a computer-based method of updating a database based on plays made by each player of a casino game. In step 149, the dealer coordinator 147 enables the hardware of the casino game. For example, the dealer coordinator 147 can enable the operations of the processor 17 and the memory 19. In step 153, the dealer 151 activates detection by the play sensor 11. In step 157, the players 155 of the casino game may position their respective player IDs 23 (e.g., RFID cards) on marked locations of the casino game table in order to allow effective detection. In other embodiments, the play sensor 11 may detect the player IDs 23 even if they are at a distance from the table. In other embodiments, the player IDs 23 may be portable electronic devices (such as smart phones) that transmit the identification data to the play sensor 11.

In step 159, the processor 17 may identify the respective players 155 upon detection of the player IDs 23. The database 41 may associate identification data of each player with the point count data. In step 161, the respective player-active indicators 29 are set to an on state as discussed above with respect to FIG. 2. In step 163, at the end of each play, the dealer 151 collects the chips and deposits them into a chip-drop container (e.g., a drop box). For example, each play may correspond to a hand played at a card game such that after each played hand the dealer 151 places the chips into the chip-drop container. In step 165, the play sensor 11 detects depositing of the chips, and the processor 17 increments the point counts of the active players 155 accordingly.

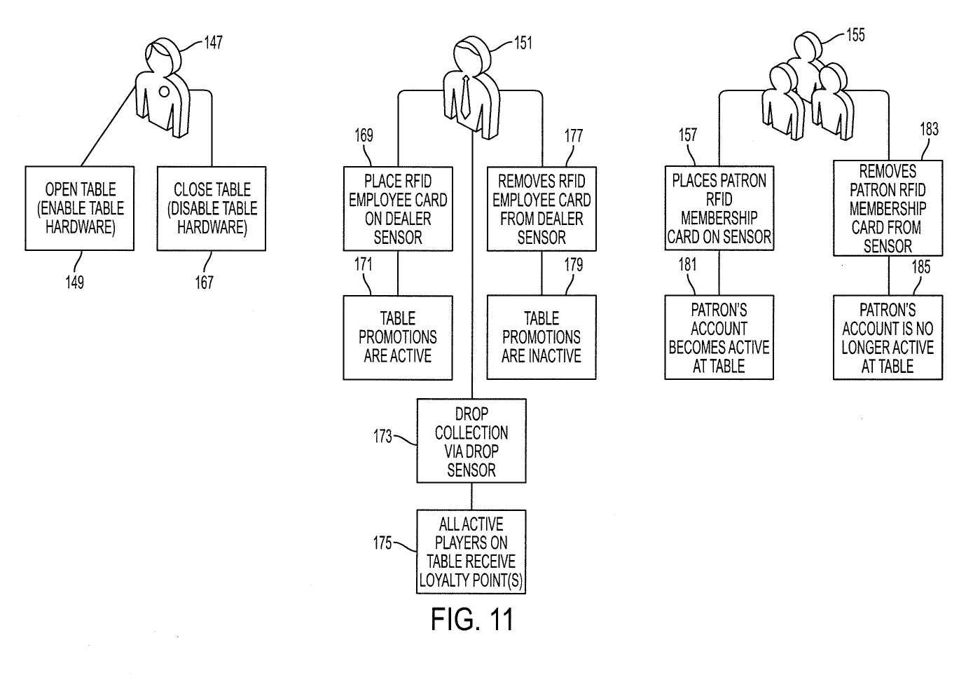

FIG. 11 is a tree diagram showing the method steps related to the dealer coordinator 147, the dealer 151 and the players 155. The dealer coordinator 147 can initially “open” the casino game by enabling the hardware in step 149 discussed above with respect to FIG. 4. After the casino game is over, or when point counting is no longer desired, the dealer coordinator 147 can deactivate the table hardware and “close” the casino game.

Referring to step 169 of FIG. 11, the dealer 151 can place a dealer-identifying device 21 in proximity of the identification sensor 15. As a result, the processor 17 activates the point counting process disclosed above with respect to FIG. 5. Once the point counting process is activated, the bets are collected in step 173, and the play sensor 11 detects the collection of the bets. In step 175, the processor 17 increments the point count for each of the players 155 with an active status.

Referring to step 157 of FIG. 11, the players 155 may place their respective player IDs 23 in proximity of the respective identification sensors 27 to allow identification. In step 181, the processor 17 sets their respective statuses to active. When a player no longer desires to play the casino game, the player can remove the respective player ID in step 183. In step 185, the processor 17 sets the player's status to inactive and no longer increments the point count for the player until the player's status is re-activated upon return to a casino game.

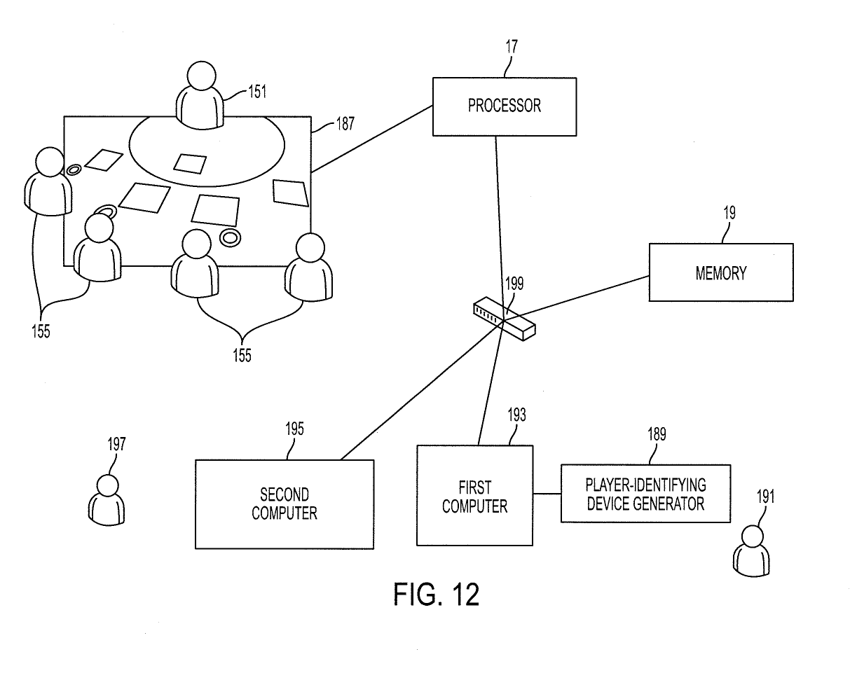

FIG. 12 is a block diagram illustrating a computer-based system for issuing player-identifying devices and redeeming accumulated points. A first computer 193 may be connected to the processor 17 and the memory 19. When a new player 191 seeks to sign up for membership, the first computer 193 may issue a new player ID using the player ID generator 189. The player ID generator 189 may generate an RFID-enabled membership card. The first computer 193 stores the identification data of the new player 191 in the memory 19. The first computer 193 may be stationed at a customer service station for issuing player IDs 23. A customer service representative may operate the first computer 193. The computer-based system may further grant access to a new player 191 for utilizing the first computer 193 (with a secure log-in access) to receive a player ID. After signing up, an identification sensor may detect the identity data of the portable electronic device using wireless communication (e.g., Bluetooth communication) as discussed above with respect to FIG. 5.

In another embodiment, the computer-based system may not include the player ID generator 189. For example, the first computer 193 can be a personal computer or a portable electronic device (such as a smart phone or a tablet) that allows a user to sign up and provide identification information. The portable electronic device can serve as a player ID.

In the card game 187, each play can be for example, a hand played by the players 155. At the conclusion of each hand of the players 155, the dealer 151 collects the placed bets (e.g., chips). Upon detection of the played hands, the processor 17 increments the respective point counts and stores the respective point counts in the memory 19. The processor 17 can be connected to the memory 19 via a network switch 199. In other embodiments, the processor 17 and memory 19 can be connected via wireless communication or other data communication means without limiting the scope of the invention.

A second computer 195 can be connected to the processor 17 and the memory 19 for allowing a previously registered player 197 to access his/her account (e.g., using secure log-in access). The previously registered player 197 can view the respective point count and redeem the respective point count to receive rewards based on the accumulated point count. Furthermore, the previously registered player 197 can update or revise his/her respective identity information.

The second computer 195 can be stationed as a kiosk for issuing rewards based on the accumulated point count of the previously registered player 197. The kiosk can have an identification sensor such as an RED reader for detecting the player ID. The kiosk can further have a display for displaying the respective accumulated point count. The previously registered player 197 can select a promotion using the second computer 195 (e.g., using a touch-screen display). For example, the second computer 195 may be connected to a printer for printing a prize for the chosen promotion (e.g., a bet voucher or a concert ticket) and a record of the respective accumulated point count and play count.

In another embodiment, the second computer 195 may be a personal computer or a portable electronic device (e.g., a smart phone or a computer tablet) connected to the processor 17 and/or the memory 19. For example, the previously registered player 197 may carry the portable electronic device as a player ID. Using the portable electronic device, the previously registered player 197 can keep track of his/her respective play count and accumulated point count in substantially real time, for example, while playing the casino game or afterwards. In other embodiments, a single computer (e.g., a smart phone) may be utilized to perform each of the foregoing processes discussed with respect to the first computer 193 and the second computer 195.

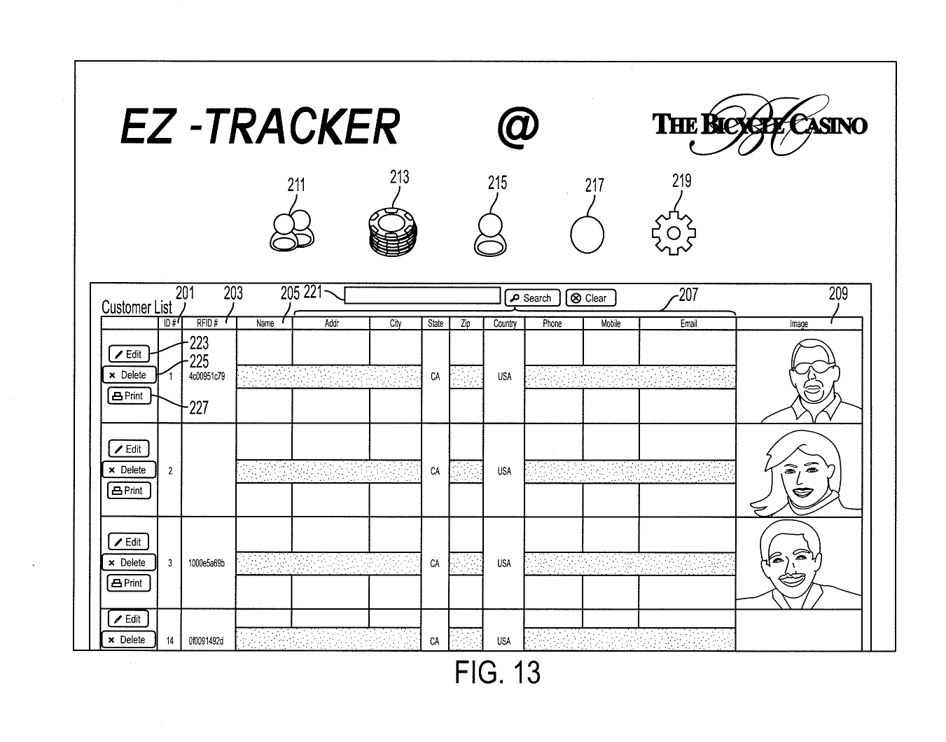

FIG. 13 is a display interface of the player tracking software with access to the database 41. Authorized personnel may view the identification data of the registered players 155 and their respective point counts using the customers option 211. A unique identification number 201 and a unique RFID number 203 are assigned to each registered player. The names 205 and contact information 207 along with a photo image 209 of each player may also be retrieved from the memory 19 to the extent such information is available. A search field 221 is provided for searching for a particular player. The data regarding the dealers and other employees and respective stored start/end times may be viewed via the employees option 215. Other administrative and system configurations and settings (for example, related to the network settings) may be modified using the EMAP option 217 and configuration option 219.

In summary, a computer-based method and a system are provided that track plays made by players of a casino game and reward points to the players based on the number of plays made. An advantageous feature of the computer-based method and system is that players would be interested in making plays more frequently to receive more valuable rewards.

Casino game players are each associated with a player IDs. The computer-based system includes an identification sensor that detects a player ID of a player. A processor connected to the identification sensor identifies the player. The processor sets the player's status to active. The system includes a memory connected to the processor for storing a point count for the player. The system includes a play sensor connected to the processor that detects each play of the player when the player's status is active. The processor increments a point count for the player when the play sensor detects a play made by the player and stores the incremented point count in the memory. The system increments point counts for every player in an active state at the casino game upon detection of each play made by the player.

The processor stores play counts of each player as sensed by the play sensor and stores the accumulated play count in the memory. The processor can determine a player's accumulated point count based on the stored play count. The processor stores the date and time of each play made by the player. A predetermined value of each play of a casino game may be used to determine the point count for each play. For example, each play of a high-stake casino game corresponds to higher points than each play of a low-stake game. An advantageous feature of this embodiment is that players have the incentive to make more plays at high-stakes casino games more frequently in order to qualify for more valuable rewards.

What is claimed is:

1. A computer-based system for awarding points to players of a casino game based on a play count of each player, the system comprising:
a first player-identifying device associated with a first player;
an identification sensor for detecting the first player-identifying device;
a processor connected to the identification sensor for detecting the first player-identifying device, identifying the first player, and setting the first player's status to active;
a memory connected to the processor for storing a point count for the first player;
a play sensor connected to the processor for detecting each play of the first player when the first player's status is active; and
the processor incrementing the point count for the first player when the play sensor detects a play by the first player, and storing the incremented point count in the memory.

2. The system of claim 1 wherein the processor is configured to accumulate the first player's play count as sensed by the play sensor and store the accumulated play count of the first player in the memory.

3. The system of claim 1 wherein the processor is configured to store the date and time of each play of the first player in the memory.

4. The system of claim 1 wherein predetermined value of play based on the casino game being played, determines the point count incremented by the processor for each play.

5. The system of claim 1 wherein the processor is configured to set the first player's status to inactive when the identification sensor no longer detects the first player-identifying device.

6. The system of claim 1 further comprising a dealer identification sensor connected to the processor for detecting a dealer-identifying device, wherein the processor is configured to activate the play sensor upon detection of the dealer-identifying device.

7. The system of claim 1 further comprising a player-active indicator connected to the processor, wherein the processor is configured to set the player-active indicator to an on state when the first player's status is active.

8. The system of claim 1 further comprising a point-increment indicator connected to the processor, wherein the processor is configured to the set the point-increment indicator to an on state when the processor increments the point count.

9. The system of claim 1, wherein the first player-identifying device is an RFID card registered to the first player, and the identification sensor is an RFID reader configured to detect the RFID card.

10. The system of claim 1 further comprising a display for displaying an image based on the first player's point count.

11. The system of claim 1 wherein the play sensor is a chip-drop sensor for detecting depositing of chips into a chip container.

12. A computer-based system for awarding points to players of a casino game based on a total play count of each player, the system comprising:
a plurality of player-identifying devices, one device for each of a plurality of players, respectively;
a plurality of identification sensors for detecting the plurality of player-identifying devices;
a processor connected to the plurality of identification sensors for detecting the player-identifying devices, identifying the players associated with each detected identity device, and setting each identified player's status to active;
a memory connected to the processor for storing a plurality of point counts, each point count associated with a respective player;
a play sensor connected to the processor for detecting each play of each active player; and
the processor incrementing an active player's point count when the play sensor detects a play and storing the incremented point count in the memory.

13. The system of claim 12 wherein the processor is configured to accumulate a play count for each active player as sensed by the play sensor and store the accumulated play count of each active player in the memory.

14. The system of claim 12 wherein the processor is configured to store the date and time of each play of each active player in the memory.

15. The system of claim 12, wherein the plurality of player-identifying devices are RFID cards registered, each RFID card registered to a respective player of the plurality of players, and the identification sensor is an RFID reader configured to detect the RFID cards.

16. A computer-based method for awarding points to multiple players of a casino game based on the number of plays by each of the players, comprising:
identifying a first player;
setting the first player's status to active;
detecting each play of the first player when the first player's status is active;
incrementing a point count of the first player for each play made by the first player; and
storing the incremented point count associated with the first player.

17. The method of claim 16, further comprising:
detecting a dealer;
storing the dealer's start time; and
activating detection of each play by the first player.

18. The method of claim 16, further comprising:
accumulating the first player's play count; and
storing the accumulated play count.

19. The method of claim 16, further comprising storing the date and time of the each play of the first player.

20. The method of claim 16, further comprising setting the first player's status to inactive when the first player stops playing the casino game.
